(19) United States
(12) Patent Application Publication
(10) Pub. No.: US 2002/0004128 A1
(43) Pub. Date: Jan. 10, 2002

(54) METHOD AND SYSTEM FOR SEALING ELECTRICAL CONNECTION USING SEALANT-IMPREGNATED FOAM

(76) Inventors: ANTHONY FORTE, MIDDLETOWN, NJ (US); DANIEL L. SWAN, RALEIGH, NC (US)

Correspondence Address: ANTEC CORPORATION, 11450 TECHNOLOGY CIRCLE, DULUTH, GA, 30097, US

(21) Appl. No.: 09/320,781

(22) Filed: May 27, 1999

Related U.S. Application Data
(60) Provisional application No. 60/087,096, filed on May 28, 1998.

(51) Int. Cl. B32B 3/06; B32B 5/14; B32B 7/12; B32B 5/22; B32B 3/26

(52) U.S. Cl. 428/308.4; 428/321.1; 428/306.6; 428/317.1; 428/317.9

(57) ABSTRACT

A foam/sealant system in which a sealant material, such as a conventional gel, is introduced into an open cell foam to provide an environmental seal for electrical connections, preferably for electrical connections that are embedded within the foam/sealant system. Sealant materials, such as gels, that require curing can be held in place by the foam while in a liquid state to eliminate difficult and costly filling methods. The gel can be cured either while the foam is located at its final location in connection with the electrical connection point to be protected, or the gel can be pre-cured in the foam and then the composite foam/sealant system can be placed in the appropriate location. Preferably, the foam is placed in the appropriate location such that the electrical connection point is embedded in the foam before the gel is introduced, thereby allowing the gel to cure in connection with the electrical connection or substrate to be protected.

### CROSS-REFERENCE TO RELATED APPLICATION

The present application claims the benefit of priority of U.S. Provisional Patent Application Ser. No. 60/087,096 filed May 28, 1998, entitled “Sealing Method for Electrical Connections Using Gel-Filled Foam.”

### FIELD OF THE INVENTION

The invention relates generally to techniques for protecting metallic substrates from environmental exposure and, more specifically, to materials and methods for sealing electrical connections in communications equipment against environmental exposure.

### BACKGROUND OF THE INVENTION

In communications networks, such as telephone networks, many devices for connecting and routing telephone lines are installed in the field. If an electrical connection in these devices is unprotected from the outside environment, it may be adversely affected by environmental factors, one of the most damaging being moisture. The damage caused by environmental agents may impair the electrical connection and cause electrical noise in the telephone line or may short-circuit the line altogether, resulting in a degradation or disruption of telephone service.

In order to avoid the adverse affects of environmental conditions on electrical connections, it is important for the connection to be protected against environmental hazards. Providing a proper environmental seal is even more important when protecting electrical connections within devices that are “re-enterable”. Re-enterable devices are common in the industry, and are devices that craftspersons repeatedly enter to inspect, repair, or alter the electrical connections therein. As will be understood, the act of re-entering a device and disconnecting and reconnecting an electrical connection requires that the sealant material work to break and then re-make the seal upon each re-entry. Numerous re-entries thus puts a stress on the environmental sealing ability of the sealant within the device.

As is common in the art, electrical connections are often protected by the use of sealants, such as gels or greases. Certain types of sealants will be defined and described below.

“Conventional gels” include silicone gels, polyurethane gels, thermoplastic gels which may use various extenders and other gel materials which exhibit the properties detailed below. Typical properties used to define a gel are ultimate elongation (measured by ASTM-D638-80 at 70°±5° F. using a type 4 die to cut the sample and at a speed of 50 cm/min), cone penetration (expressed in units of 10⁻¹ mm and measured by ASTM-D217-68 at 70°±5° F., on an undisturbed sample using a standard 1:1 scale cone, the penetration being measured after 5 seconds), tensile strength (measured by ASTM-D638-80, under the same conditions as ultimate elongation), and elastic modulus (measured at 70°±5° F., using parallel late rheometric test at a frequency of one hertz). Conventional gels typically have a cohesive strength greater than their adhesive strength to the containment means in which they are cured. Conventional gels are defined by the following properties:

| | |
|---|---|
| Ultimate elongation | >200% |
| Cone penetration | 150 to 350 (10⁻¹) mm |
| Tensile strength | <20 psi |
| Elastic modulus | <10 million dynes/cm² |

“Unconventional gels” include gel material that have properties that fall outside the range specified above for conventional gels.

“Sealant materials” is a broad term that includes thixotropic greases and waxes, as well as conventional and unconventional gels, all of which are considered reenterable.

A typical problem with sealant materials other than conventional gels, such as greases, is that they lack any three-dimensional structure and often tend to flow from the area in which they are to protect. Conventional gels are typically more desirable than greases because they have more structure than greases, are self-healing, form interfaces which can be reentered and remade, and can be cured either in the presence of or away from the substrate to be environmentally protected. Although gels have these benefits, conventional gels do have several disadvantages, as described below.

Gels that have high cone penetrations can be too soft to stay in place in a device in which sealing is to be performed. Gels also tend to adhere to both the substrate and to any objects inserted into the gel. In other words, conventional gels can be too tacky. Gels can also stretch too much if their ultimate elongation is too high. All of these disadvantages make conventional gels difficult to handle, difficult to position within a device, and it is also difficult to remove an object inserted into such gel. Furthermore, gel also has an unappealing residue that remains on the fingers of anyone who touches the gel.

Gel adheres to larger surface areas rather than smaller ones. Prior devices utilize surface treatments to increase the effective surface area of a part of a device in which gel is to be placed. This characteristic of gel does not permit easy insertion into the gel of an object having a large surface area, because the gel tends to adhere to the inserted object, thereby deforming the gel, instead of allowing the object to pierce the gel smoothly. Also, the tendency of gel to stick to high surface areas means that when a device having a large surface area is removed from the gel, gel tends to stick onto the device being removed.

When an object, such as a wire, is to be inserted into the gel, wire guides are typically necessary because gels do not provide sufficient structure to act as a wire guide. When inserted into the gel, the wire may not go straight into the gel to its intended destination, and therefore a wire guide is required. This adds undesirable expense and complexity to a device that uses gel.

Gel has poor shear performance in that when two adjacent sections of gel are moved in a shearing manner, fractures are caused in the gel. These fractures degrade the sealing ability of the gel because gels do not provide protective surface films as do other sealant materials (i.e., greases). Therefore, using gel sealants under shear conditions may expose an electrical connection to environmental hazards.

Gel cannot easily be shaped into predetermined shapes or forms. The gel has little three-dimensional structure, and does not hold its shape very well without a containment means. This means that gel may ooze out of apertures in a device, such as a wire entry port. To solve this problem, a grommet or tape is often placed over such apertures to prevent gel from oozing out and also to prevent a glob of gel sticking to a wire that is pulled out from the gel.

There are also several disadvantages of gel that are problematic during the process of filling a device with gel.

Gels are compositions that are typically formed by combining two or three liquid parts together and then allowing the combination of ingredients to cure. Therefore, the liquid mixture must be contained during the cure time. This requires that the cavity or other area in which the gel is to be cured must be “water-tight” such that no leaks occur. Therefore, steps must be taken to seal off every aperture or part of the device where gel is not desired.

Also, the proportions of the different parts must be closely adhered to or the resultant cured gel composition will have characteristics outside the desired range of values discussed above. Further, it should be noted that the target properties of a gel are usually design-specific. The window of acceptable properties for a given design may be much more narrow than what is defined herein as a conventional gel. Forming a gel with the proper characteristics, such as cone penetration, is critical to the overall sealing ability of the gel in its application, and therefore the performance of the overall device. If these liquid ingredient proportions are incorrect, then the device into which the liquid parts are poured may be rendered scrap because it is very difficult or impossible to remove the cured composition from the device.

It is very difficult, given the characteristics of the gel, to selectively place gel in a particular location. As discussed above, gel is formed by combining different liquid ingredients and allowing them to cure, so the only manner of putting gel into a device is to fill a cavity with the liquid parts, which will conform to the shape of the cavity. This prevents selective placement of gel.

The adhesion of gels to most polymer surfaces is typically poor, absent a surface treatment to increase the surface area of the surface. Therefore, without surface treatments, objects placed into the gel and then subsequently removed from the gel may pull the gel off of the surface, especially if the object has a larger surface area than the polymer surface, since the gel tends to adhere to objects having large surface areas. Also, gel cannot be ultrasonically welded, glued, or otherwise attached to a surface.

Relatedly, it is very difficult to pre-cure gel and then place the gel into the desired location. If this is attempted, a good contact with the surface is not achieved, and leak paths are created. Also, surface adhesion is reduced. Therefore, for optimum sealing capability, the gel must be cured in contact with the surface of the cavity or wall on which the gel will rest.

Therefore, it is clear that although gels have desirable characteristics, they also have many undesirable characteristics, both in terms of the gel material itself and in the process of filling a device with gel, that makes the sealing of electrical connections problematic.

### SUMMARY OF THE INVENTION

The present invention is a foam/sealant system in which a sealant material, such as a conventional gel, is introduced into a carrier such as an open cell foam to provide an environmental seal for electrical connections, preferably for electrical connections that are embedded within the foam/sealant system. Sealant materials, such as gels, that require curing can be held in place by the foam while in a liquid state to eliminate difficult and costly filling methods. The gel can be cured either while the foam is located at its final location in connection with the electrical connection point to be protected, or the gel can be pre-cured in the foam and then the composite foam/sealant system can be placed in the appropriate location. Preferably, the foam is placed in the appropriate location such that the electrical connection point is embedded in the foam before the gel is introduced, thereby allowing the gel to cure in connection with the electrical connection or substrate to be protected.

### BRIEF DESCRIPTION OF THE DRAWINGS

FIG. 1 is a cross-sectional view showing a portion of sealant-impregnated foam, in accordance with the present invention.

FIGS. 2A-E are cross-sectional views showing an embedded connection within the foam/sealant system in accordance with the present invention.

FIG. 3 is an example of one type of device that uses the foam/sealant system of the present invention to seal electrical connections.

### DETAILED DESCRIPTION

The present invention includes impregnating a carrier, such as an open cell foam with a sealant material, such as a conventional gel, to provide an environmental seal for a substrate or electrical connections, and preferably for electrical connections that are embedded within the foam/sealant system. Various low density open cell foam materials will not interfere with insertion of small wires or test probes, and electrical interconnections can be made despite the presence of the foam. When die cut, molded, or inserted over somewhat sharp objects, the foam may be positioned to interface with a substrate without significant residual stresses on the foam. Coupled with partial or complete saturation of the foam with sealant material using various methods, the system provides a new level of environmental sealing performance for applications that require a reenterable, self healing sealant. This performance results from the combined properties of the selected foam and the selected sealant material. Additionally, the present invention provides new process methods for applying sealant materials to a device having an electrical connection to be protected. Because the foam acts as a carrier for containing the sealant material, the sealant may be selectively located within the foam so as to reduce the amount of sealant required or suspend the sealant in a location in which it would otherwise not remain. Sealant materials that require curing can be held in place by the foam while in a liquid state to eliminate difficult and costly filling methods. Also, unlike thixotropic sealants or gels, the foam/sealant system can be easily handled and manually applied in -a given shape.

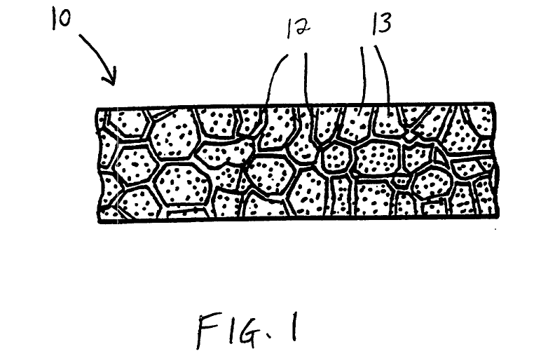

FIG. 1 shows a portion of a carrier, such as open-cell foam 12, impregnated with a sealant material 13. As used herein, the term “foam” includes open cell foam materials typically characterized by density and number of pores per cubic inch. Foam densities can vary, but a density of approximately 2 lb/ft³ is preferable. The cells of the foam preferably have an average volume of approximately 0.01 inch³, but the cells may also be any other suitable size. It should bye noted that a wide variety of materials can be foamed, such as polyurethane, polyethylene, polyether, polyester, or silicon, and can be in sheet form or cut into specific shapes which are application-dependent. The foam need not be rectangular or block-shaped as shown in FIG. 1, but can be die cut or molded to work with very complex geometry, as required by a particular application. The foam/gel composition can also be compressed in a device to conform to almost any desired shape.

Preferably, the sealant material is a conventional gel having properties within the ranges defined above. However, the sealant material can also be any other suitable sealant material, or combination thereof, such as unconventional gel, grease, wax, or any other acceptable material that provides environmental sealing. The sealant material, or the constituent liquid parts thereof, is introduced into the foam in any suitable manner, such as by injection, immersion, gravity pour, wicking, or other suitable manner. If the sealant material is a gel that requires curing, then the constituent parts of the gel may be introduced into the foam in liquid form and allowed to cure. The gel can be allowed to cure either while the foam is located at its final location within a device, or the gel can be pre-cured in the foam and then the composite foam/sealant system can be placed in the appropriate location. In accordance with the preferred embodiment of the present invention, the foam is placed in the appropriate location such that the electrical connection point in embedded in the foam before the gel is introduced, thereby allowing the gel to cure in connection with the electrical connection or substrate to be protected. However, the present invention may also be utilized in any application where the sealing of environmental hazards is required, such as by sandwiching an electrical connection between two foam/sealant portions or in any other suitable manner. Also, it will be understood that the present invention can be utilized to seal a particular area, such as a surface or a cavity, from environmental hazards, such as by using the foam/sealant system as a gasket or by using the foam/sealant on a surface or cavity to be protected.

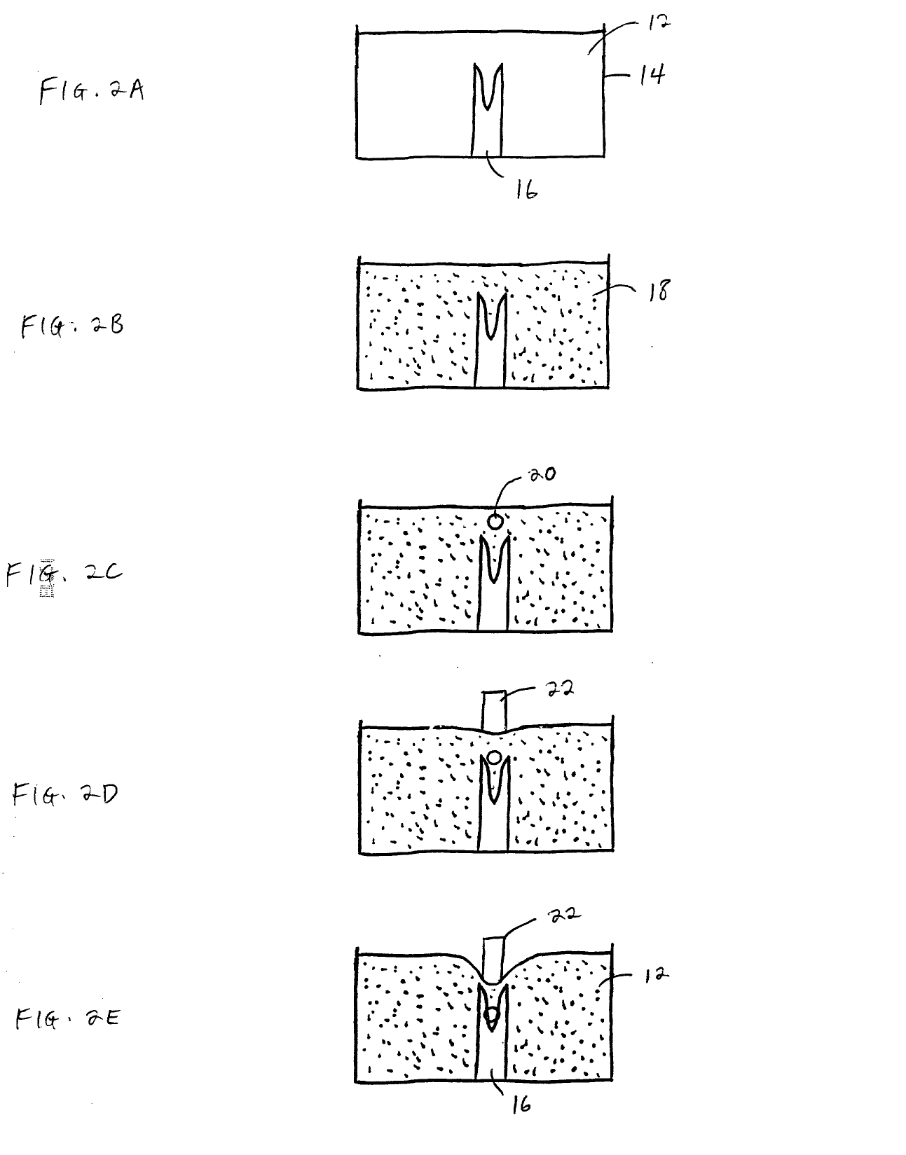

The present invention is preferably used to provide environmental sealing to an electrical connection that is embedded within the foam/sealant system. An example of such an embedded electrical connection is shown in the cross-sectional views of FIGS. 2A-E. As discussed above, the foam 12 can be placed in a location in a device, such as in a cavity defined by walls 14. An electrical connector, such as an IDC 16, is inserted into the foam such that the IDC cuts the foam during insertion. Alternatively, the IDC can be installed in the cavity first and then the foam can be placed around the IDC. Either way, the foam 12 is cut by the IDC 16 and surrounds the IDC, as shown in FIG. 2A.

The sealant material, such as gel, is then introduced into the foam as shown in FIG. 2B such that the entire IDC is surrounded by foam/sealant combination 18. If the sealant is a gel, the gel is allowed to cure in contact with the IDC. It will be understood that this allows the gel to cure, within the cells of the foam, in contact with the IDC, where the electrical connection to be protected is made.

As shown in FIG. 2C, an object to be connected to the IDC, such as wire 20, is then inserted into the foam/sealant above the blades of the IDC. The wire pierces some of the interstices of the foam, but other cells of the foam act as a guide to keep the wire in a relatively straight path as it is being inserted into the foam/sealant, which is beneficial when it is desired to insert the wire to a specific location, such as over the blades of an IDC or other connector. This guiding function of the foam therefore eliminates the need for a mechanical wire guide. It will be understood that when the wire is inserted into the foam/sealant, the wire is surrounded by foam/sealant.

A driver 22, or some other suitable mechanism, is used to push the wire downward so that the blades of the IDC cut into the insulation of the wire until the metal core of the wire is electrically connected between to the IDC, as shown in FIG. 2D. When the wire is pushed downward, the driver necessarily pushes down the foam/sealant located above the wire. The driver compresses this portion of the foam/sealant downward as the wire is pushed downward between the blades of the IDC.

As the wire is pushed further downward into the IDC to make the electrical connection, as shown in FIG. 2E, the foam/sealant is compressed some more, but again completely surrounds the wire. In this manner, the connection point between the wire and the IDC is surrounded bay foam/sealant, thereby providing an environmental seal to the electrical connection. If the wire is removed from the IDC, the foam/sealant will decompress and will return to the position substantially as shown in FIG. 2B.

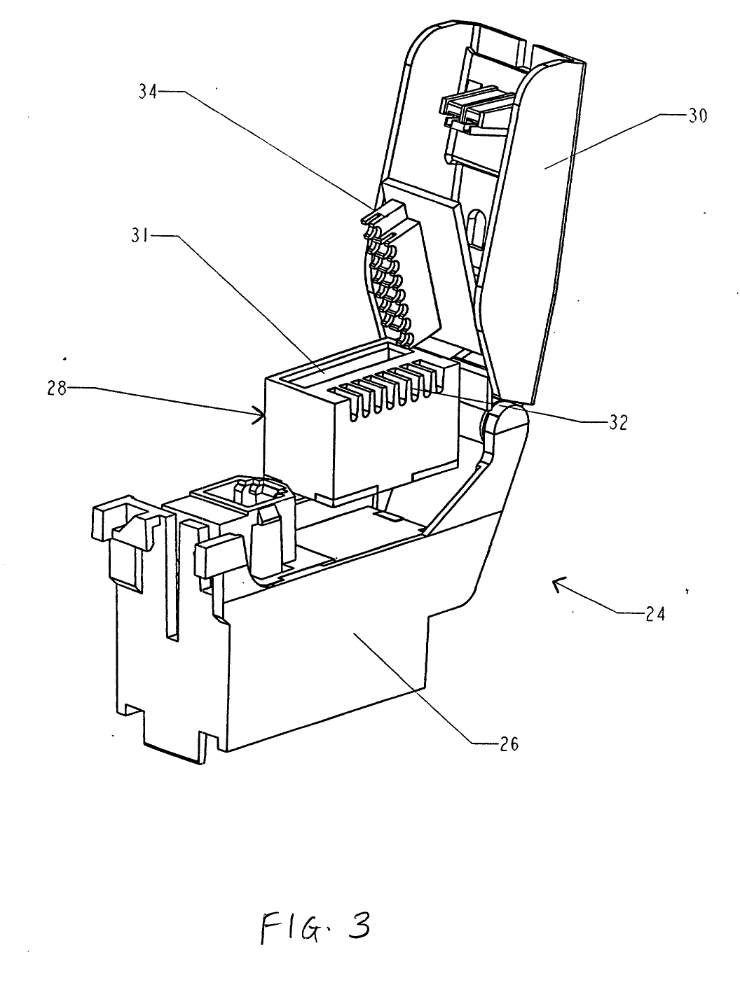

The present invention can be utilized to protect any type of electrical connection or substrate in any suitable device. As an example, one device in which the present invention can be used is a line module 24, as shown in FIG. 3, for connecting subscriber lines to telephone company (telco) lines. The line module has a generally rectangular housing 26, a raised hinged IDC bridge 28 hingedly connected to the housing, and a cover 30 which is also hingedly connected to the housing which closes on top of the raised hinged bridge. The IDC bridge has a top, a bottom, and four side walls defining a cavity 31. The subscriber lines enter the raised hinged bridge through wire entry ports 32. A plurality of IDCs (not shown) are provided within the cavity and are connected at one end to the telco lines. As shown in FIG. 2, each IDC has a pair of upwardly extending arms or blades, with a slot between the blades. The slot becomes progressively more narrow toward the bottom of the IDC. A foam/sealant combination (not shown) is provided in the cavity such that it surrounds the IDCs. If gel is used as the sealant, it is introduced as a liquid into the foam in the cavity and is cured in place around the IDCs. The gel or other sealant material is constrained within the cells of the foam so that the sealant material surrounds the IDCs.

A driver 34 is provided between the IDC bridge and the cover. The subscriber wires are inserted through the wire entry ports on the bridge such that the wires enter that portion of the foam/sealant above the IDC, such as is shown in FIG. 2C. The cover is then closed, thereby causing the driver to push down on the raised hinged bridge and thereby compress the foam/sealant above the wire as it is pushed down into the slot of the IDC to establish an electrical connection that is embedded within the foam/sealant system.

The foam/sealant system can also be used to protect any substrate or electrical connection point other than those discussed herein. As stated above, the gel, or other sealant, can be cured within the foam either prior to contact with the electrical connection point, or in contact with the electrical connection point or substrate.

The inventive foam/sealant system allows for the use of all currently known sealant materials for introduction into the foam and effectively transforms the properties of these sealant materials into a new composite foam/sealant material with combined properties. While by strict definition the new foam/sealant may not be considered homogeneous, it is effectively so for its intended applications. For example, interconnection wires as small as 26 AWG stranded may easily be inserted into the foam/sealant at any location despite the physical structure of the foam. In addition, the foam structure does not impair the making or breaking of sensitive connections with IDCs or other common interconnections. With improved ability to keep a sealant material in its intended location by maintaining the sealant within the cells of the foam, the inventive foam/sealant system provides additional reliability for material in its intended location for environmentally sealing exposed electrical circuits or contacts which are designed for repeated testing, reentry, and reuse.

In addition to conventional applications, foam/sealants can be applied in ways other than ways in which thixotropic sealants or gels can be applied today. Partial saturation of a foam may sometimes result in a functional, less-expensive sealing solution and may allow the sealant to be placed where it would not otherwise remain. Gels are particularly difficult to apply, since they are introduced in a low-viscosity, uncured state or as a molten thermoplastic. Any cavities to be filled must be leak-proof until the gel is cured or cooled, and adequate adhesion of the gel to its container is sometimes difficult. Foam/sealants may be used as preforms which can be installed in assembly operations, or the foam may be used as a sponge to contain the uncured gel or the thermoplastic gel in a location in which the material may or may not normally stay without difficult fixturing.

Gel, grease, or other sealant materials may include, but are not limited to, urethane, silicon, KRATON® compounds, and other cross-linked thermoplastic gels. The foam can be impregnated with uncured gel or grease so as to form a composition that has structure but which can still be easily penetrated by an object such as an IDC or a wire. The gel can be introduced into the foam outside of any device or the foam, preformed, can be placed into the device to be sealed, with the gel or other sealant subsequently introduced into the foam. Thus, the substrate to be protected can be introduced into the foam at any stage, e.g., (1) before foam is placed in the device; (2) after the foam is placed in the device but before the sealant is introduced into the foam, or (3) after the foam/sealant composition is introduced (uncured or cured).

There are many advantages of the inventive foam/sealant system over the existing gel sealants. The foam provides a much larger surface area to which the sealant material can adhere. The foam additionally gives a structure to the gel that the gel does not otherwise have. Therefore, the range of cone penetration and other properties of the sealant can be much wider because the foam acts as a carrier or structure for containing the sealant. In this manner, the wide range of acceptable properties of the sealant material enlarges the number of types of sealants that can be used with the foam to accomplish the sealing task. As an example, instead of being required to use gel, other sealants can be used instead of gel, and the impregnated foam maintains the sealant within its cells, thereby providing sealing capabilities for any electrical connection embedded within the foam. Additionally, the foam imparts limited shape memory characteristics to non-gel sealant materials. It also makes the gel production and curing process easier because the range of acceptable material parameters makes the mixing proportions of gel ingredients less strict.

Each open cell within the foam acts independently to seal a substrate or electrical connection within that cell. The size of each cell limits the elongation of the sealant material within that particular cell. This minimizes the amount of sealant lost. For example, if a wire is pushed into the foam/sealant, the cells of the foam around the wire will have a limited elongation, so that when the wire is pulled out of the foam/sealant, some gel in an outside cell may adhere to the wire, but the gel in cells within the foam will not adhere to the wire but instead stays adhered to the foam. This prevents sealant from being pulled out of the sealing area when an object is removed.

The foam/sealant has a lower surface tackiness because the foam holds the sealant within its cells. In other words, when a finger touches the foam/sealant, the cells of the foam have a larger surface area than the finger, and so the sealant is maintained more within the cells and does not stretch as a finger is pulled away from the sealant. Also, when a finger touches the foam/sealant, the finger necessarily touches both foam and sealant, so the tackiness of the overall foam/gel system is lower.

The overall characteristics of the foam/sealant system, such as ultimate elongation, cone penetration, and others properties, are different than that of pure sealant. This is because the ultimate elongation, for example, of the foam is much lower than sealant such as gel, so the ultimate elongation of the overall foam/sealant system is limited by that of the foam rather than that of the gel. Therefore, the introduction of gel into the foam creates a foam/sealant system that has properties such as ultimate elongation, cone penetration, etc. that are different than those of pure gel, but by impregnating gel, or other sealant, within the cells of the foam, the beneficial sealing characteristics and properties of the gel within the foam are utilized to seal the electrical connection point or substrate.

The shear performance of the overall foam/sealant system is much better than pure gel. Even if the foam/sealant is sliced, the cells of the foam maintain gel within the cells and prevents gel within those cells from shearing from other gel in adjacent cells.

The foam can be made or cut into any desired shape and then filled with sealant, thereby providing the structure to allow the sealant to effectively be retained in any desired shape, which would not be possible with pure sealant material.

The foam also can act as a filler, requiring less sealant to be used to fill a particular area. Because sealants material such as gel can be expensive, this is advantageous.

The foam can be mechanically connected to or retained in a device, such as the line module shown in FIG. 3. Specifically, the foam/sealant system can be ultrasonically welded, or even glued, to plastic or other suitable materials, thereby not relying on surface adhesion of the sealant to hold the sealant within a cavity. Prior methods of retaining sealants such as gel within a cavity have included surface treatments to increase the surface area of the cavity.

As discussed above, the foam acts as a “wipe” to retain sealant within the foam and to prevent sealant material from adhering to an object, such as a wire, that is removed from the gel. Prior methods used tape over an aperture to act as a wipe; the present invention eliminates the requirement for tape or any other outside mechanical device to prevent leakage of sealant and to act as a wipe.

The foam/gel system also has advantages in the process of applying sealant to a device for sealing purposes. By introducing gel or other sealant into a foam, there is much less of a need to contain the sealant because the foam acts to contain the constituent liquid gel parts as the gel is curing. Therefore, there is much less need to physically seal off every small aperture or leak path in a cavity in which the foam/sealant is to be placed.

If the gel cures improperly within the foam, the entire foam/sealant system can be more easily removed from the device in which it is placed and re-filled, thereby rendering fewer pieces as scrap.

By using foam, gel can be selectively placed within a portion of the foam, so that gel, or voids, can be intentionally located in specific parts of the foam.

The gel can be either pre-cured prior to contact with the electrical connection or substrate to be protected, or it can be cured in place around the electrical connection or substrate. One of the major benefits of the foam/sealant system is that sealants having characteristics outside the range of conventional gels can be used, without the drawbacks of using pure sealants. For example, a sealant having a cone penetration of 350 to 400 (10⁻¹) mm, which is outside the cone penetration range for a conventional gel, can be introduced into the foam and the sealant will not leak or ooze out of the cells of the foam because the cells of the foam hold the sealant within the foam. By itself, such a sealant material is liquidy and soft, but when impregnated within the cells of the foam, the sealant is retained within the foam. In this manner, the foam allows a wider range of sealants to be used for environmental sealing electrical connections, while eliminating the drawbacks of using non-gel sealants.

While the preferred embodiments of the invention have been shown and described, it will be obvious to those skilled in the art that various modifications and alterations can be made thereto without departing from the spirit and scope of the invention as defined in the appended claims.

What is claimed is:

1. A system for sealing an electrical connection from environmental hazards, comprising:
a carrier having a plurality of interconnected cells;
an electrical connection point embedded within said carrier; and
a sealant material introduced into said carrier to impregnate at least some cells of said carrier such that said sealant material in said cells of said carrier surrounds said electrical connection point and seals said electrical connection point from environmental hazards.

2. The system of claim 1 wherein said carrier is an open cell foam.

3. The system of claim 1 wherein said sealant material is a conventional gel.

4. The system of claim 3 wherein said gel is introduced into said carrier while in a liquid state and cures while in contact with said embedded electrical connection point.

5. The system of claim 3 wherein said gel within said carrier is cured prior to contact with said embedded electrical connection point within said carrier.

6. The system of claim 1 wherein said carrier can be preformed into a desired shape prior to being filled with sealant material.

7. The system of claim 1 wherein said sealant material is a grease.

8. The system of claim 1 wherein said sealant material is a wax.

9. The system of claim 1 wherein said sealant material is an unconventional gel.

10. The system of claim 9 wherein said gel is introduced into said carrier while in a liquid state and cures while in contact with said embedded electrical connection point.

11. The system of claim 9 wherein said gel within said carrier is cured prior to contact with said embedded electrical connection point within said carrier.

12. The system of claim 1 wherein said sealant material is a combination of different sealant materials.

13. The system of claim 1 wherein an object to be electrically connected at said electrical connection point is inserted into said sealant-impregnated carrier.

14. The system of claim 13 wherein said cells within said carrier act as a guide for said object when said object is inserted into said sealant-impregnated carrier.

15. The system of claim 1 wherein said electrical connection point comprises an insulation displacement connector.

16. The system of claim 1 wherein said carrier is located within a device having a structure, and wherein said carrier can be mechanically attached to said structure.

17. The system of claim 16 wherein said carrier is ultrasonically welded to said structure.

18. The system of claim 1 wherein said carrier is impregnated with said sealant material only in selected areas within said carrier.

19. A method for sealing an electrical connection point within a device from environmental hazards, comprising the steps of:
providing in said device a carrier having a plurality of interconnected cells;
embedding said electrical connection point within said carrier;
impregnating at least some cells of said carrier with a sealant material such that said sealant material in said cells of said carrier surrounds said electrical connection point and seals said electrical connection point from environmental hazards.

20. The method of claim 19 wherein said carrier is an open cell foam.

21. The method of claim 19 wherein said sealant material is a conventional gel.

22. The method of claim 21 wherein said step of impregnating further comprises introducing said gel into said carrier while in a liquid state and curing said gel while in contact with said embedded electrical connection point.

23. The method of claim 21 wherein said step of impregnating further comprises curing said gel prior to said step of embedding said electrical connection point within said carrier.

24. The method of claim 19 wherein said step of impregnating further comprises impregnating said carrier with said sealant material only in selected areas within said carrier.

25. The method of claim 19 wherein said sealant material is a combination of different sealant materials.

26. The method of claim 19 further comprising the step of mechanically attaching said carrier to said device.

27. The method of claim 26 wherein said step of mechanically attaching comprises ultrasonically welding said carrier to said structure.

28. A system for sealing a substrate from environmental hazards, comprising:
a carrier having a plurality of interconnected cells;
a sealant material introduced into said carrier to impregnate at least some cells of said carrier such that said sealant material in said cells of said carrier seals said substrate from environmental hazards.

29. The system of claim 28 wherein said carrier is an open cell foam.

30. The system of claim 28 wherein said sealant material is a conventional gel.

31. The system of claim 30 wherein said gel is introduced into said carrier while in a liquid state and cures while in contact with said substrate.

32. The system of claim 30 wherein said gel within said carrier is cured prior to contact with said substrate.
